(19) United States
(12) Patent Application Publication
(10) Pub. No.: US 2009/0112809 A1
(43) Pub. Date: Apr. 30, 2009

(54) Systems and methods for monitoring health of computing systems

(75) Inventors: Matthew Louis Wolff, Antioch, TN (US); Zaid Amer Altalib, Nashville, TN (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/976,398

(22) Filed: Oct. 24, 2007

(51) Int. Cl. G06F 17/30

(52) U.S. Cl. 707/3; 707/E17.014

(57) ABSTRACT

A method for determining health of computing systems is disclosed. The method comprises receiving a plurality of health determining metrics from at least one computing system. The method also includes calculating the health determinant value based on the plurality of health determining metrics. A first portion of the health determinant value is determined by dividing a number of executable threads available in the at least one computing system by a total number of executable threads in the at least computing system. A second portion of the health determinant value is determined by dividing a number of database connections available in the at least one computing system by a total number of database connections in the at least one computing system. Furthermore, the health determinant value may be compared with at least one threshold health value. The method may also include providing status indication of the health determinant value.

### TECHNICAL FIELD

The present disclosure relates generally to a system for monitoring, and more particularly, to a system and method for automated health monitoring of financial systems.

### BACKGROUND

Computing systems are an integral part of today's business world. In fact, many organizations rely solely on computing systems and networks (e.g., the Internet or an intranet) to perform many integral aspects of their business. For example, many companies buy and sell large quantities of goods and services over the Internet. Additionally, many organizations employ computers and computer networks to advertise and market products to potential customers throughout the world. Indeed, computing systems and associated networks are critical to most any modern enterprise.

Because so many businesses rely on computing systems and networks associated with such systems, any downtime of computing systems or networks may have significant consequences on the productivity of a business. For example, in the finance sector, a credit or lending agency may receive thousands of requests per day from merchants, vendors, retailers, dealers, or purchasing outlets regarding the credit-worthiness of a potential customer or client. The lending agency may subsequently request historical data associated with the customer from a variety of sources, both internal and external to the agency. For example, the lending agency may request a credit history from an external credit bureau or other lenders. Alternatively or additionally, the lending agency may request information from an internal accounting or financing database to determine any past financial relationships with the customer, such as previous purchases, loan repayment information, or any other information that may be used to determine the credit-worthiness of the customer. Consequently, any problems, delays, or downtime associated with one or more of these systems may delay a final financing decision, which may cause the customer to take business to a different lending agency and/or dealer. Thus, in order to limit the potential loss of revenue associated with computing system or computing network downtime, a system for monitoring the health of a computing system and/or networks and resources associated therewith, may be required.

One method of monitoring the resources utilized by a computing system to reduce downtime is described in U.S. Pat. No. 7,216,169 (the '169 patent) issued to Clinton et al. on May 8, 2007. The '169 patent describes a system having an extendable set of registered provider services, a health engine subsystem, and a number of user interfaces. The set of registered provider services provide computer health information (such as security, privacy, backup, performance, etc.) to the health engine subsystem. The health engine subsystem receives health status information from the provider services, and uses the health status information to update and formulate a health score, health status notifications, and instructions for corrective action. The health engine subsystem then passes the health score, health status notifications, and instructions for corrective action to the user interface. A user of the system can then initiate corrective action by selecting to proceed with the corrective action.

Although the system of the '169 patent may be configured to monitor certain aspects of provider services associated with a personal computer, it may be limited in certain situations. For example, the system of the '169 patent may not be configured to monitor executable threads and/or connections with one or more databases or network resources such as, for example, third party web-addresses and/or internal or external database connections. As a result, financial organizations that rely on continuous and/or on-demand access to one or more of these resources may not become aware of potential connection problems until the user tries to access the resource. This may lead to unnecessary delays in acquisition of information and, if the information is critical to a time-sensitive transaction, a potential loss of business.

The presently disclosed systems and methods for monitoring the health of computing systems are directed toward overcoming one or more of the problems set forth above.

### SUMMARY

An aspect of the present disclosure is directed to a method for determining a health determinant value. The method includes querying at least one computing system for a plurality of health determining metrics, and receiving the plurality of health determining metrics from the at least one computing system. The method also includes calculating the health determinant value based on the plurality of health determining metrics, wherein a first portion of the health determinant value is determined by dividing a number of executable threads available in the at least one computing system by a total number of executable threads in the at least one computing system, and a second portion of the health determinant value is determined by dividing a number of database connections available in the at least one computing system by a total number of database connections in the at least one computing system. The method further includes comparing the health determinant value to at least one threshold health value, and providing a status indication of the health determinant value.

In another aspect, the present disclosure is directed to a computer-readable medium for use on a computing system, the computer-readable medium including computer-executable instructions for performing a method for monitoring health of computing systems. The method includes querying at least one computing system for a plurality of health determining metrics, and receiving the plurality of health determining metrics from the at least one computing system. The method also includes calculating a health determinant value based on the plurality of health determining metrics, wherein a first portion of the health determinant value is determined by dividing a number of executable threads available in the at least one computing system by a total number of executable threads in the at least one computing system, and a second portion of the health determinant value is determined by dividing a number of database connections available in the at least one computing system by a total number of database connections in the at least one computing system. The method further includes comparing the health determinant value to at least one threshold health value, and providing a status indication of the health determinant value.

### BRIEF DESCRIPTION OF THE DRAWINGS

FIG. 1 is a block diagram of an exemplary architecture associated with a system for monitoring the health of computing systems, consistent with certain disclosed embodiments; and

FIG. 2 is a flowchart illustrating an exemplary method for monitoring the health of computing systems, which may be performed in connection with the system of FIG. 1, consistent with certain disclosed embodiments.

### DETAILED DESCRIPTION

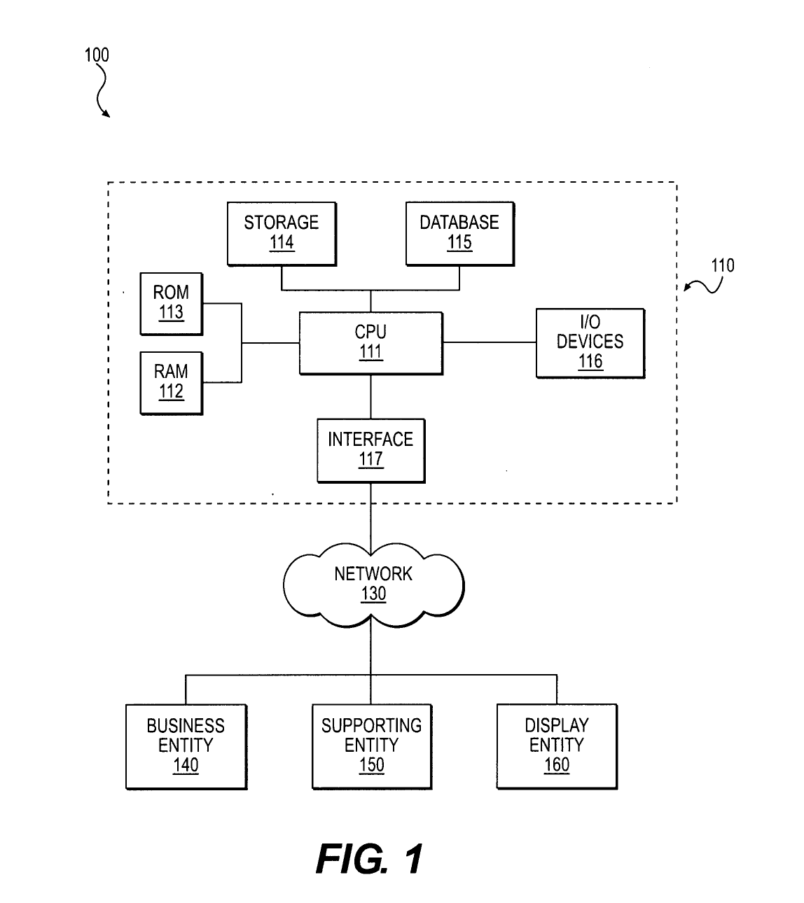

FIG. 1 illustrates an exemplary system architecture 100 in which principles and methods consistent with the disclosed embodiments may be implemented. As shown in FIG. 1, system architecture 100 may include one or more hardware and/or software components configured to collect, monitor, store, analyze, evaluate, distribute, report, process, record, and/or sort information associated with automated monitoring of system health. For example, system architecture 100 may include computing system 110, network 130, business entity 140, supporting entity 150, and display entity 160.

Computing system 110 may include one or more hardware and/or software components such as, for example, a central processing unit (CPU) 111, a random access memory (RAM) module 112, a read-only memory (ROM) module 113, a storage 114, a database 115, one or more input/output (I/O) devices 116, and an interface 117. Computing system 110 may be configured to receive, collect, analyze, evaluate, report, display, and distribute data related to the automated processing of financial systems. Accordingly, computing system 110 may include one or more software components or applications to perform specific processing and analysis functions associated with the disclosed embodiments. For example, computing system 110 may be configured to manage and track customer and product data requests, including customer requests for credit for the purchase of one or more products, and perform automated processing of customer requests based on the received credit data. Computing system 110 may include, for example, a mainframe, a server, a desktop, a laptop, and the like.

CPU 111 may include one or more processors, each configured to execute instructions and process data to perform functions associated with computing system 110. As illustrated in FIG. 1, CPU 111 may be connected to RAM 112, ROM 113, storage 114, database 115, I/O devices 116, and interface 117. CPU 111 may be configured to execute computer program instructions to perform various processes and methods consistent with certain disclosed embodiments. The computer program instructions may be loaded into RAM 112 for execution by CPU 111.

RAM 112 and ROM 113 may each include one or more devices for storing information associated with an operation of computing system 110 and/or CPU 111. For example, ROM 113 may include a memory device configured to access and store information associated with computing system 110, including information for identifying, initializing, and monitoring the operation of one or more components and subsystems of computing system 110. RAM 112 may include a memory device for storing data associated with one or more operations performed by CPU 111. For example, instructions from ROM 113 may be loaded into RAM 112 for execution by CPU 111.

Storage 114 may include any type of storage device configured to store any type of information used by CPU 111 to perform one or more processes consistent with the disclosed embodiments. For example, storage 114 may include one or more magnetic and/or optical disk devices, such as hard drives, CD-ROMs, DVD-ROMs, or any other type of media storage device.

Database 115 may include one or more software and/or hardware components that store, organize, sort, filter, and/or arrange data used by computing system 110 and/or CPU 111. Database 115 may be configured as a relational database, distributed database, or any other suitable database format. A relational database may be in tabular form where data may be organized and accessed in various ways. A distributed database may be dispersed or replicated among different locations within a network. For example, database 115 may store historical information such as dealer purchasing, return and credit history, product data, product sales data, and the like. The historical information may be associated with the management, tracking, and forecasting of product sales, or any other information that may be used by CPU 111 to perform automated processing of a computing system. Database 115 may also include one or more analysis tools for analyzing information within the database. Database 115 may store additional and/or different information than that listed above.

I/O devices 116 may include one or more components configured to communicate information with a user associated with computing system 110. For example, I/O devices 116 may include a console with an integrated keyboard and mouse to allow a user to input parameters associated with computing system 110. I/O devices 116 may also include a user-accessible disk drive (e.g., a USB port, a floppy, CD-ROM, or DVD-ROM drive, etc.) to allow a user to input data stored on a portable media device. Additionally, I/O devices 116 may include one or more displays or other peripheral devices, such as, for example, a printer, a camera, a microphone, a speaker system, an electronic tablet, or any other suitable type of input/output device.

Interface 117 may include one or more components configured to transmit and/or receive data via network 130. In addition, interface 117 may include one or more modulators, demodulators, multiplexers, de-multiplexers, network communication devices, wireless devices, antennas, modems, and any other type of device configured to enable data communication via any suitable communication network. It is further anticipated that interface 117 may be configured to allow CPU 111, RAM 112, ROM 113, storage 114, database 115, and one or more input/output (I/O) devices 116 to be located remotely from one another and perform the collection, analysis, and distribution of data or other information.

Computing system 110 may include additional, fewer, and/or different components than those listed above and it is understood that the components listed above are exemplary only and not intended to be limiting. For example, one or more of the hardware components listed above may be implemented using software. According to one embodiment, storage 114 may include a software partition associated with one or more other hardware components of computing system 110. Additional hardware or software may also be required to operate computing system 110. Such hardware and software may include, for example, security applications, authentication systems, dedicated communication systems, or any other suitable hardware of software configured to support operations of computing system 110. The hardware and/or software may be interconnected and accessed as required by authorized users. In addition, one or more portions of computing system 110 may be hosted and/or operated by a third party.

As explained, computing system 110 may access network 130 via interface 117. Network 130 may embody any appropriate communication network allowing communication between or among one or more entities. Network 130 may include, for example, the Internet, a local area network, a workstation peer-to-peer network, a direct link network, a wireless network, or any other suitable communication platform. Interface 117 may be communicatively coupled with network 130 using wired connections, wireless connections, or any combination of wired and wireless connections.

Business entity 140 may comprise a computing system associated with a customer, dealer, wholesaler, merchant, retailer, vendor, reseller, or other type of entity authorized to conduct transactions using the disclosed embodiments. Business entity 140 may include primary customers (e.g., primary dealers in a resale environment, end customers in a direct sales environment, etc.), secondary customers (e.g., secondary dealers in a resale environment, end customer in a resale environment, etc.), and/or any other suitable business customer. Business entity 140 may be in data communication with computing system 110 via network 130. Although business entity 140 is illustrated in FIG. 1 as a single entity, it is contemplated that any number of business entities may be included as part of system architecture 100.

Supporting entity 150 may comprise one or more computing systems or electronic resources that may be accessible by computing system 110. For example, supporting entity 150 may include accounting systems and/or corporate office systems that reside on a corporate intranet. Alternatively and/or additionally, supporting entity 150 may include one or more computing systems or databases associated with credit tracking agencies accessible via a remote network, such as the Internet. Furthermore, supporting entity 150 may include automated systems that respond to requests for information. In one embodiment, supporting entity 150 may be an automated system that returns a loan interest rate for a customer based on the customer's income, past credit history, and/or credit score. In another embodiment, supporting entity 150 may be an automated system that creates and transmits legal and/or financial documents such as, for example, repayment contracts, financing terms and conditions, loan amortization schedules, etc., based on finance approval. A request for information from supporting entity 150 may be generated by business entity 140, routed though computing system 110, and delivered to supporting entity 150. Supporting entity 150 may, in turn, provide the requested information to business entity 140 via computing system 110.

Display entity 160 may represent systems that display health information regarding system architecture 100 on any number of display systems. Display entity 160 may include for example, televisions, monitors, speakers, or any other audio and/or video means of communicating information that is known in the art.

Display entity 160 may connect to network 130 using any suitable computing device, such as, for example a desktop computer, a laptop computer, a mainframe computer, a client device, a handheld computing device, a telephone, etc. The connection between display entity 160 and network 130 may be through any wired or wireless device, or any combination thereof. Furthermore, there is no limit to the amount of display entities that can be connected to computing system 110 through network 130.

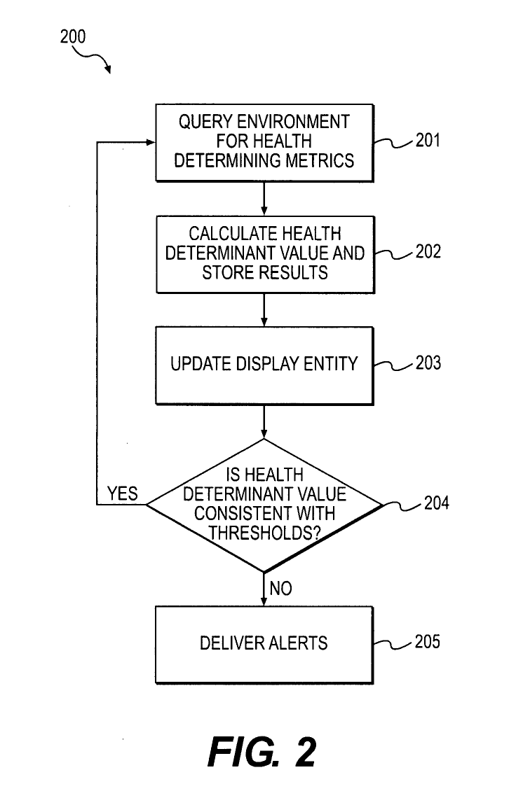

FIG. 2 illustrates a flowchart depicting a method of generating a health determinant value. FIG. 2 will be discussed in the following section to further illustrate the disclosed system and its operation.

### INDUSTRIAL APPLICABILITY

The disclosed system may provide a method of communicating requested operational and environmental information associated with a computing system, and from the requested information determine the health of a computing system. In particular, the disclosed method and system may query a locally or remotely located computing system to determine current operating performance information (health determining metrics). The health determining metrics may then be used to formulate a health determinant value, update a display entity of the health determinant value, and alert at least one system administrator associated with managing the appropriate operations of the computing system.

As illustrated in the flowchart 200 of FIG. 2, the system health determination process may include computing system 110 continuously or repeatedly querying for, and receiving of, health determining metrics from one or more of computing system 110, business entity 140, and/or supporting entity 150 associated with system architecture 100 (Step 201). Health determining metrics, as the term is used herein, refers to any information that may be used by computing system 110 to analyze and evaluate the health, responsiveness, accessibility, and/or status of one or more systems or resources that may be required by computing system 110 to properly execute its requisite functions. For example, one health determining metric may include the availability and responsiveness of executable threads associated with processes to be performed by one or more of computing system 110, business entity 140, and/or supporting entity 150. In another example, a health determining metric may include network connection characteristics (e.g., network traffic statistics, network bandwidth, response time(s), network connection status information (e.g., offline), etc.) between one or more computing system 110, business entity 140, and/or supporting entity 150 or any other electronic databases or third party server accessible to computing system 110. For instance, one health determining metric may be based on a time required for computing system 110 to respond to a data request from business entity 140. Similarly, a health determining metric may be derived as a function of time required for supporting entity 150 to respond to a query for health determining metrics from computing system 110.

According to one embodiment, a health determining metric may include a status associated with a communication queue (such as Java Message Service (JMS)) such as, for example, the number of unsent or backlogged messages in the queue, the time required to deliver messages from the queue, etc. Furthermore, a health determining metric may include an amount of time that a Uniform Resource Locator (URL) takes to respond to a request for information. Alternatively or additionally, a health determining metric may include information associated with a status and/or responsiveness of an authentication server that verifies the identity of data requests from one or more of computing system 110, business entity 140, and/or supporting entity 150.

The transmittal of the health determining metrics may also contain information regarding the destination to which the health determining metrics are to be sent, and the date, time of day, and frequency at which the transmission(s) is to occur.

In addition to querying for health determining metrics, computing system 110 may also provide health status configuration information to one or more of business entity 140 and supporting entity 150. For example, computing system 110 may specify a destination address to which health determining metrics are to be delivered (for processing). Additionally, computing system 110 may specify specific times (e.g., day, date, time of day, frequency) for gathering and transferring health determining metrics. This feature may allow users to customize specific times for analyzing system health. Accordingly, organizations that rely on maintenance of system health during certain peak periods may query for health metrics more frequently during these periods.

After receiving the health determining metrics, computing system 110 may use the information to determine a health determinant value (Step 202). In one embodiment, a first portion of the health determinant value may be determined by dividing the number of executable threads available in system architecture 100 by the total number of executable threads in system architecture 100. A second portion of the determinant value may be calculated by dividing the number of database connections available in system architecture 100 by the total number of database connections in system architecture 100.

In determining health determinant values, computing system 110 may apply a weight factor to one or more health determining metrics and/or certain portions of the health determinant value. For example, health determining metrics associated with connections to frequently-accessed resources that are critical to making certain time-sensitive decisions may be weighted more heavily than health determining metrics associated with connections to infrequently-accessed resources or resources that have readily available alternatives.

According to one embodiment, the first portion of the health determinant value described above may be weighted to comprise about 75% of the value of the health determinant score, while the second portion of the health determinant value may be weighted to comprise about 25%. However, it is contemplated that any weight factor or combination of weight factors may be applied without departing from the scope of the present disclosure. Thus, the presently disclosed health determinant system enables users to customize the importance of individual systems to the overall functionality of the computing system.

The determination of the health determinant value in step 202 may also include a demerit system that reduces the determinant value under certain circumstances. In one embodiment, the state of the executable threads and database connections, as described above, may correspond to a health determinant value of 85. If the number of messages in a JMS queue exceeds a certain threshold, the demerit system may reduce the health determinant value by 10, thereby making the health determinant value 75. In another embodiment, the state of the executable threads and database connections may correspond to a health determinant value of 90. If any instance of authentication in the authentication server, as described above, fails to work properly, the demerit system may cause the health determinant value to be reduced by 5, thereby making the health determinant value 85. In yet another embodiment, no matter what the health determinant value is, the demerit system may set the health determinant value to zero if one or more components of system architecture 100 does not respond to a request for information (Step 201) within a predetermined time. For example, computing system 110 may repeatedly or continuously query a URL in system architecture 100 to see if the URL is functioning (online). If the URL does not respond to the repeated or continuous query in a predetermined amount of time, the health determinant value may be set to zero.

After the health determinant value has been determined, the health determinant value, as well as the information used in calculating the health determinant value may be stored in computing system 110, or a computer-readable medium remote from computing system 110, for future analysis.

Once the health determinant value has been determined and stored (Step 202), computing system 110 may update display entity 160 with the health determinant value and/or the information used in determining the health determinant value (Step 203). By updating display entity with real-time health determining metrics and health determinant values, system administrators may be provided with up-to-the-minute statistics. As a result, system administrators may be able identify, monitor, and track trends in health data associated with individual systems.

After display entity 160 is updated in step 203, computing system 110 may determine whether the health determinant value is consistent with a threshold health determinant value (Step 204). For example, according to one embodiment, if the health determinant value exceeds a threshold health determinant value (indicating that computing system, and resources associated therewith, are operating appropriately), computing system 110 may return to step 201 and continue monitoring the health of system architecture 100. If, on the other hand, the health determinant value is less than the threshold health determinant value, computing system 110 may notify at least one system administrator of the current health determinant value.

Health event notifications may be distributed using any acceptable notification format such as, for example, a short message service (SMS) message sent to wireless or portable device associated with a system administrator, an automated phone call, a wireless page, a wireless signal to an operator station, a facsimile, any form of electronic message, or in any other appropriate format (Step 205). The notification may include any one or all of the details associated with the determination of the health determinant value. Specifically, the notification may include the day, date, and time of the health alert. Alternatively or additionally, the notification may include information identifying the specific systems, entities, executable threads, databases, connections, and/or processes that may be contributing to the low health. Once the notification in step 205 has been delivered, computing system 110 may return to step 201 to request information regarding the health of system architecture 100.

Furthermore, those familiar with the art will appreciate that the steps in flowchart 200 may be implemented non-consecutively. For example, in one embodiment, computing system 110 may continuously query system architecture 100 for health determining mectrics. In addition to the continuous query, the health determinant value may be calculated periodically (e.g., every 10 seconds). Still further, the display entity 160 may be updated periodically as well (e.g., every 30 seconds).

Although the disclosed embodiments are described in connection with computing systems operating in the financial sector, they may be applicable to any computing system that relies on the compilation of information from a plurality of resources. Specifically, the presently disclosed systems and methods may be implemented in any computing system where it may be advantageous to automatically monitor the computing system's access to one or more other computing systems, databases, software applications, or other electronic resources. As a result, the systems and methods for monitoring health of computing systems described herein may provide organizations that rely on centralized servers with a method for monitoring the resources required to maintain the operation of these servers, generating a health score based on the availability of these resources, and providing the health score to a system administrator.

The presently disclosed systems and methods for monitoring the health of computing systems may have several advantages. For example, the systems and methods described herein provide a solution for automatically monitoring executable threads and database connections associated with both internal and external computing resources. As a result, problems associated with one or more executable threads and/or databases may be identified shortly after the problem arises, which may enable system administrators to proactively solve the problem without excessive productivity loss or computing system downtime. This may be particularly advantageous in computing systems associated with the financial sector, where delays in response times may result in a loss of business. One characteristic example for monitoring the health of a computing system will now be presented.

According to one embodiment, a user may define a threshold health value of 60, and store this threshold in computing system 110 for use during health monitoring of system architecture 100. Accordingly, health determinant values less than 60 may trigger a heath alert, while health determinant values greater than 60 may be indicative of normal operation of system architecture 100. During health monitoring of system architecture 100, computing system 110 may continuously query system architecture 100 for a plurality of health determining metrics. The health determining metrics may include the amount of executable threads available in a computer system, the amount of database connections available in a computer system, the number of instances of authentications in the authentication servers that are working properly, the amount of computer instructions waiting to be executed in JMS queues, and a number of URLs that respond to queries within a predetermined time period (e.g., 3 seconds).

In response to a health metric query, computing system 110 may determine that system architecture 100 has 75 executable threads available out of 100 total executable threads in system architecture 100. Furthermore, computing system 110 may determine that system architecture 100 has 70 database connections available out of 100 total database connections in system architecture 100. Computing system 110 may also determine that all instances of authentications in the authentication servers are working properly, 1 JMS queue has more than 5 unsent computer instructions, and all queried URL's respond to the query within 3 seconds.

Computing system 110 may subsequently calculate the health determinant value based on weight factors assigned to one or more of the health determinant metrics. For example, the executable thread analysis may account for 75% of the health determinant value, while the available database connections may account for 25% of the health determinant value. Thus, because 75 out of a possible 100 executable threads are available, and 70 out of a possible 100 database connections are available, the health determinant value may be calculated as (75*0.75)+(70*0.25), or 73.75.

As explained, a demerit system may be employed as part of the health determinant system to reduce the health determinant value based on certain peripheral criteria. For example, because 1 JMS queue had more than 5 unsent computer instructions, the health determinant value may be reduced by 5, to 68.75.

Computing system 110 may then use computer-executable instructions to automatically update display entity 160 with the health determinant value. Since the health determinant value of 68.75 is greater then the established threshold health value of 60, no critical health alerts may be required.

It will be apparent to those skilled in the art that various modifications and variations can be made to the disclosed systems and methods for monitoring the health of computing systems without departing from the scope of the disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A method for determining a health determinant value, comprising:
querying at least one computing system for a plurality of health determining metrics, and receiving the plurality of health determining metrics from the at least one computing system;
calculating the health determinant value based on the plurality of health determining metrics, wherein a first portion of the health determinant value is determined by dividing a number of executable threads available in the at least one computing system by a total number of executable threads in the at least computing system, and a second portion of the health determinant value is determined by dividing a number of database connections available in the at least one computing system by a total number of database connections in the at least one computing system;
comparing the health determinant value to at least one threshold health value; and
providing a status indication of the health determinant value.

2. The method of claim 1, wherein providing the status indication of the health determinant value includes displaying the health determinant value on at least one display entity.

3. The method of claim 1, wherein providing the status indication of the health determinant value includes storing the health determinant value, and providing at least one alarm signal to at least one system administrator.

4. The method of claim 3, wherein the at least one alarm signal comprises at least one electronic message.

5. The method of claim 1, wherein calculating the health determinant value further comprises establishing a demerit system that uses a plurality of preset conditions to determine a demerit value that is used to reduce the health determinant value.

6. The method of claim 5, wherein a portion of the demerit value corresponds to a number of undelivered computer instructions in a queue associated with the at least one computing system.

7. The method of claim 5, wherein a portion of the demerit value corresponds to an amount of time elapsed for the at least one computing system to respond to the query.

8. The method of claim 5, wherein a portion of the demerit value corresponds to a number of authentication instances functioning improperly in at least one authentication server.

9. The method of claim 1, wherein the first portion is weighted to comprise about 75 percent of the health determinant value, and the second portion is weighted to comprise about 25 percent of the health determinant value.

10. A computer-readable medium for use on a computing system, the computer-readable medium including computer-executable instructions for performing a method for monitoring health of computing systems, the method comprising:
querying at least one computing system for a plurality of health determining metrics, and receiving the plurality of health determining metrics from the at least one computing system;
calculating a health determinant value based on the plurality of health determining metrics, wherein a first portion of the health determinant value is determined by dividing a number of executable threads available in the at least one computing system by a total number of executable threads in the at least computing system, and a second portion of the health determinant value is determined by dividing a number of database connections available in the at least one computing system by a total number of database connections in the at least one computing system;
comparing the health determinant value to at least one threshold health value; and
providing a status indication of the health determinant value.

11. The computer-readable medium of claim 10, wherein providing the status indication of the health determinant value includes displaying the health determinant value on at least one display entity.

12. The computer-readable medium of claim 10, wherein providing the status indication of the health determinant value includes storing the health determinant value, and providing at least one alarm signal to at least one system administrator.

13. The computer-readable medium of claim 12, wherein the at least one alarm signal comprises at least one electronic message.

14. The computer-readable medium of claim 10, wherein calculating the health determinant value further comprises establishing a demerit system that uses a plurality of preset conditions to determine a demerit value that is used to reduce the health determinant value.

15. The computer-readable medium of claim 14, wherein a portion of the demerit value corresponds to a number of undelivered computer instructions in a queue associated with the at least one computing system.

16. The computer-readable medium of claim 14, wherein a portion of the demerit value corresponds to an amount of time elapsed for the at least one computing system to respond to the query.

17. The computer-readable medium of claim 14, wherein a portion of the demerit value corresponds to a number of authentication instances functioning improperly in at least one authentication server.

18. The computer-readable medium of claim 10, wherein the first portion is weighted to comprise about 75 percent of the health determinant value, and the second portion is weighted to comprise about 25 percent of the health determinant value.

19. A system for monitoring health of computing systems, comprising:
an interface communicatively coupled to a display entity and at least one of a business entity and a supporting entity;
a processor communicatively coupled to the interface and configured to:
transmit, via the interface, a query to the at least one of a business entity and a supporting entity, the query requesting a plurality of health determining metrics;
receive, via the interface, the plurality of health determining metrics from the at least one of a business entity and a supporting entity in response to the query;
calculate a health determinant value based on the plurality of health determining metrics, wherein a first portion of the health determinant value is determined by dividing a number of available executable threads associated with the at least one of a business entity and a supporting entity by a total number of executable threads associated with the at least one of a business entity and a supporting entity, and a second portion of the health determinant value is determined by dividing a number of available database connections associated with the at least one of a business entity and a supporting entity by a total number of database connections associated with the at least one of a business entity and a supporting entity;
store the health determinant value;
compare the health determinant value to at least one threshold health value; and
provide a status indication of the health determinant value.

20. The system of claim 19, wherein the processor is further configured to:
display the health determinant value on at least one display entity;
generate at least one alarm signal corresponding to the status indication; and
provide the at least one alarm signal to the at least one system administrator in a form of an electronic message.
